(19) United States
(12) Patent Application Publication
(10) Pub. No.: US 2026/0226344 A1
(43) Pub. Date: Aug. 6, 2026

(54) POLYMER COMPRISING SILICON NANOPARTICLES DISPERSED THEREIN FROM SILICON NANOPARTICLE COATED POLYMER PIECES

(71) Applicant: Dow Silicones Corporation, Midland, MI (US)

(72) Inventors: James A. Casey, Midland, MI (US); David Witker, Midland, MI (US)

(21) Appl. No.: 19/151,365

(22) PCT Filed: Feb. 1, 2024
(86) PCT No.: PCT/US2024/013986

§ 371 Date: Jul. 28, 2025

Related U.S. Application Data
(60) Provisional application No. 63/444,593, filed on Feb. 10, 2023.

(51) Int. Cl. C09K 11/59; B82Y 40/00; C08J 3/12; C08K 9/02; C09K 113/00

(52) U.S. Cl. CPC C09K 11/59; C08J 3/128; C08K 9/02; B82Y 40/00; C08K 2201/005; C08K 2201/011; C09K 2113/00

(57) ABSTRACT

Prepare a polymeric host matrix material with silicon nanoparticles dispersed therein by: (a) providing pieces of polymeric host matrix material coated with silicon nanoparticles; (b) softening the pieces of polymeric host matrix material coated with silicon nanoparticles to form softened pieces of polymeric host matrix material; and (c) blending the softened pieces of polymeric host matrix material together with the silicon nanoparticles on the surface of the softened pieces of polymeric host matrix material to form a single mass of polymeric host matrix material with silicon nanoparticles dispersed therein.

### FIELD OF THE INVENTION

The present invention relates to polymer materials having silicon nanoparticles dispersed therein and processes for making such polymer materials from silicon nanoparticle coated polymer pieces.

### INTRODUCTION

The advent of nanotechnology is resulting in a paradigm shift in many technological arts because the properties of many materials change at nanoscale dimensions. For example, decreasing the dimensions of some structures to nanoscales can increase the ratio of surface area to volume, thus causing changes in the electrical, magnetic, reactive, chemical, structural, and thermal properties of the material. Nanomaterials are already being found in commercial applications and will likely be present in a wide variety of technologies including computers, photovoltaics, optoelectronics, medicine/pharmaceuticals, structural materials, military applications, and many others within the next few decades.

Silicon nanoparticles are one desirable type of nanoparticle. An important characteristic of small less than 10 nanometers (nm) average size) silicon nanoparticles is that these silicon nanoparticles are photoluminescent in visible light when stimulated by lower wavelength sources (UV). This is thought to be caused by a quantum confinement effect that occurs when the diameter of the nanoparticle is smaller than the exciton diameter, which results in bandgap bending (that is, increasing of the gap). Researchers have shown how the bandgap energy (in electron volts) of a nanoparticle changes as a function of the diameter of the nanoparticle.

Although silicon is an indirect bandgap semiconductor in bulk, silicon nanoparticles with average sizes of less than 10 nm emulate a direct bandgap material, which is made possible by interface trapping of excitons. Direct bandgap materials can be used in optoelectronics applications as silicon quantum dot materials. Silicon quantum dots are particularly desirable over other quantum dot materials because they do not require environmentally unfriendly components such as lead, selenide, cadmium, indium, arsenide or even germanium. Another interesting property of nanomaterials is the lowering of the melting point following the surface-phonon instability theory. Researchers have shown that the melting point of a nanomaterial formed of nanoparticles changes as a function of the diameter of the nanoparticle.

There are applications that benefit from having silicon nanoparticles dispersed within a composition, often known as a “host matrix”, such as a polymer. However, it can be difficult to disperse nanoparticles directly into a host matrix, particularly without experiencing agglomeration of the silicon nanoparticles. Some efforts in prior art describe dispersing nanoparticles into monomers and then polymerizing the monomers to obtain a polymeric host matrix with the nanoparticles dispersed therein. However, that requires a formulator to accommodate handling monomers and conducting polymerizations. It is desirable to identify an efficient method for dispersing silicon nanoparticles directly into a polymeric host matrix material without having to handle monomers and polymerization procedures to disperse the nanoparticle into a polymeric matrix.

### BRIEF SUMMARY OF THE INVENTION

The present invention provides an efficient method for dispersing silicon nanoparticles directly into a polymeric host matrix without having to disperse the silicon nanoparticles into monomers that are then polymerized into a polymeric matrix material. The present method can also provide a means of achieving a concentrating silicon nanoparticles within a polymer matrix material using differential flow rates of polymer and silicon nanoparticles.

The present invention is a result of discovering that not only can silicon nanoparticles be deposited onto pieces of polymeric host matrix material during manufacturing the silicon nanoparticles, but that silicon nanoparticles are thermally and physically stable enough to allow silicon nanoparticle coated pieces of polymeric host matrix material to be melt blended and even hot pressed to form a polymeric host matrix with silicon nanoparticles dispersed throughout the polymeric host matrix. Even when the silicon nanoparticles are silicon quantum dots, they survive the temperatures of melt blending and hot pressing to produce polymer compositions having silicon quantum dots dispersed therein. Even more surprising is that flowing a thermoplastic polymeric host matrix containing dispersed silicon nanoparticles can undergo differential flow between the silicon nanoparticles and thermoplastic polymer host matrix so as to result in a concentrating effect of silicon nanoparticles by inducing flow of the thermoplastic polymeric host matrix material. This result seems to a consequence of a phenomenon where the silicon nanoparticles flow slower than a thermoplastic polymeric host matrix, resulting in a concentrating effect of silicon nanoparticles within the thermoplastic polymeric host matrix that avoids agglomerating silicon nanoparticles. This concentration procedure allows one to obtain higher concentrations of silicon nanoparticles within a thermoplastic polymeric host matrix than is achievable by direct mixing of nanoparticles into the thermoplastic polymeric host matrix without agglomeration.

In a first aspect, the present invention is a method for preparing a polymeric host matrix material with silicon nanoparticles dispersed therein, the method comprising: (a) providing pieces of polymeric host matrix material coated with silicon nanoparticles; (b) softening the pieces of polymeric host matrix material coated with silicon nanoparticles to form softened pieces of polymeric host matrix material; and (c) blending the softened pieces of polymeric host matrix material together with the silicon nanoparticles on the surface of the softened pieces of polymeric host matrix material to form a single mass of polymeric host matrix material with silicon nanoparticles dispersed therein.

The process of the present invention is useful for dispersing silicon nanoparticles into a polymeric host matrix.

### BRIEF DESCRIPTION OF DRAWINGS

FIG. 1 illustrates a schematic of the VHFLPP set up for use in preparing the examples herein.

### DETAILED DESCRIPTION OF THE INVENTION

Products identified by their tradename refer to the compositions available under those tradenames on the priority date of this document.

“Multiple” means two or more. “And/or” means “and, or as an alternative”. All ranges include endpoints unless otherwise indicated.

“Cx to Cy”, “Cₓ-C_{y}”, “C_{x-y}” are interchangeable and refer to a composition having a number of carbon atoms in a range of from x to y.

“Silicon nanoparticle” refers to a silicon-based particle having an average particle size of less than one micrometer, typically a particle size of 100 nanometers (nm) or less, while at the same time having an average particle size of one or more than one nm. Dynamic light scattering or transmission electron microscopy image analysis are common ways to determine average particle size for silicon nanoparticles. Silicon nanoparticles include silicon quantum dots.

“Silicon-based” refers to a composition comprising silicon. A silicon-based material generally contains 40 percent (%) or more, and can contain 50% or more, 60% or more, 70% or more, 80% or more, 90% or more, even 100% silicon atoms or a combination of silicon and oxygen atoms based relative to all atoms in the material.

“Silicon quantum dots” refer to silicon nanoparticles that have a crystalline silicon structure and that photoluminesces when exposed to light. Typically, silicon quantum dots have an average particle size that is in a range of one to 10 nanometers, preferably in a range of one to 6 nanometers, more preferably in a range of one to 5 nanometers. Silicon quantum dots are characterized by the fact that they luminesce when exposed to light having a wavelength in a wavelength range of 300 to 477 nanometers, corresponding to blue and ultraviolet light.

The present invention is a process for preparing a polymeric host matrix material with silicon nanoparticles, preferably silicon quantum dots, dispersed therein. The polymeric host matrix material is a softenable material, meaning it can be softened by heating and/or addition of a solvent and becomes firmer upon cooling and/or removal of solvent. Desirably, the polymeric host matrix material is polymeric, preferably a thermoplastic polymer. The polymeric host matrix material can be crystalline, semi-crystalline or amorphous. Examples of suitable polymers that can be polymeric host matrix materials include homopolymer and copolymers. Examples of suitable polymers that can be polymeric host matrix material include any one or any combination of more than one polymer selected from a group consisting of polyethylene, polypropylene, polybutadiene, poly(methyl methacrylate), polystyrene, polyisoprene, poly(vinyl butyral), poly(lactic acid), and poly(amide). Polyethylene includes variations of polyethylene such as low density polyethylene, linear low density polyethylene, and high density polyethylene.

The process of the present invention involves providing pieces of polymeric host matrix material coated with silicon nanoparticles, softening the pieces of polymeric host matrix material to form softened pieces of polymeric host matrix material; and then blending the softened pieces of polymeric host matrix material together with the silicon nanoparticles on the surface of the softened pieces of polymeric host matrix material to form a single mass of polymeric host matrix material with silicon nanoparticles dispersed therein. “Pieces” with respect to pieces of polymeric host matrix material can be of any form such as, for example, any one or any combination of more than one of pellets, powders, granules, flakes, plates, chips, blocks, and pieces of sheets or films.

In the broadest scope of the invention, providing pieces of polymeric host matrix material coated with silicon nanoparticles can be accomplished in any manner. Exemplary methods of providing pieces of polymeric host matrix material coated with silicon nanoparticles include methods of: (1) spray coating pieces of polymeric host matrix material with silicon nanoparticles; (2) directly depositing silicon nanoparticles onto pieces of host matrix material upon making the silicon nanoparticles; and (3) depositing silicon nanoparticle into a capture fluid containing pieces of polymeric host matrix material upon making the silicon nanoparticles. Each of these methods desirably uses a very high frequency low pressure plasma (VHFLPP) process to prepare silicon nanoparticles.

### VHFLPP Process

VHFLPP processes are generally known processes for making nanoparticles, and in the case of the present application silicon nanoparticles including silicon quantum dots. The VHFLPP process provides capability to provide better control over particle size and size distribution when producing nanoparticles than other processes for making nanoparticles offer. Examples of VHFLPP processes are taught in prior art, including in US2013/0189446, US2012/0326089 and WO2020/205850. A basic description of the VHFLPP process follows.

The VHFLPP process uses a gas stream comprising at least one nanoparticle precursor that flows through a quartz tube at a pressure below 13,333 Pascals (Pa). To make silicon nanoparticles, the nanoparticle precursor is or comprises a silicon-containing material typically selected from a group consisting of silanes, disilanes, halogen-substituted silanes, halogen-substituted disilanes, C₁ to C₄ alkyl silanes, C1 to C4 alkyl disilanes and mixtures of any combination thereof. The gas stream can contain additional precursors (dopants) that typically contain a component, or any combination of components selected from a group consisting of halogens, germanium, boron, phosphorus and nitrogen. The combined concentration of nanoparticle precursor and dopant in the gas stream typically ranges from 0.1 to 50 percent by volume (vol %) relative to the gas stream composition. The balance of the gas stream is primarily one or a combination of more than one inert gas such as argon (Ar), Helium (He), Neon (Ne), Krypton (Kr), Xenon (Xe), and Radon (Rn).

Exterior and concentric to the quartz tube are two ring electrodes, typically copper ring electrodes separated from one another with one ring electrode “upstream” (relative to the gas stream) with respect to the other ring electrode. A plasma is created within the quartz tube by powering the upstream ring electrode with a radio frequency source while grounding the other ring electrode. The radio frequency is a very high frequency (typically ranging from 30 to 500 Megahertz) and is coupled to a power typically ranging from 80 to 1000 Watts.

The nanoparticle precursor breaks down, nucleates and grows into nanoparticles as it flows through the plasma. The pressure at the plasma is 6666 Pascals (Pa) or less, and preferably 667 Pa or less while at the same time is typically 133 Pa or more.

The nanoparticles continue to flow in the gas stream and exit the quartz tube through an orifice into a collection chamber. The collection chamber is at a pressure of less than 13.33 Pascals (Pa) while the gas stream is flowing. When the gas stream is not flowing, the collection chamber is typically at a pressure of 6.67×10⁻⁵ Pa.

The VHFLPP process can be run as a continuous or a pulsed process. A continuous VHFLPP process uses a constant and continuous radio frequency on the upstream ring electrode. In contrast, a pulsed VHFLPP process uses an amplitude modulated very high frequency (VHF) radio frequency signal applied to the upstream ring electrode. The amplitude modulated signal is typically operated from 1 to 50 Kilohertz as a square wave wavefunction that is multiplied to the continuous VHF sinusoidal waveform. Advantages to a pulsed process include using pulsed energy to control the size of the nanoparticles produced by controlling the residence time nanoparticle precursors are exposed to the high power plasma as they pass through the VHF glow discharge. In a continuous VHF plasma process (non-modulated), nanoparticle size can be controlled by the concentration of the nanoparticle precursor, silicon in the case of silicon nanoparticles and the residence time of the precursor through the VHF plasma.

### Spray Coating Method

In the spray coating method of providing pieces of polymeric host matrix material, it is desirable to collect nanoparticles in a capture fluid, transfer them to a solvent and then spray coat them onto pieces of polymeric host matrix material.

When collecting silicon nanoparticles in a capture fluid, position the capture fluid in the collection chamber of the VHFLPP process in the path of the flow of the gas stream containing the nanoparticles. The distance between the surface of the capture fluid and the orifice of the quartz tube is desirably in a range of 5 to 50 orifice diameters. The gas stream containing nanoparticles impinges the surface of the capture fluid thereby introducing the nanoparticles into the capture fluid where the nanoparticles collect. Typically, in order to assist dispersing the nanoparticles in the capture fluid, the capture fluid is agitated (for example, stirred or subjected to ultrasonic agitation) during nanoparticle collection and/or the reservoir containing the capture fluid rotates during nanoparticle collection. After capture is complete, it is also helpful to sonicate the capture fluid containing the nanoparticles to facilitate dispersing of the nanoparticles.

The capture fluid should have a vapor pressure sufficiently low so as to remain primarily intact in the reservoir within the collection chamber during the VHFLPP process. The capture fluid is desirably non-aqueous. Examples of suitable capture fluids include mineral oil, silicone oils (such as polydimethylsiloxane (PDMS), phenyl methyl-dimethyl cyclosiloxane, tetramethyltetraphenyltrisiloxane, and pentaphenyltrimethyltrisiloxane), fluorocarbons and alkylene oxide oils. The capture fluid can be a blend of more than one fluid. Additional desirable properties and examples of suitable capture fluids are taught in WO2020/205850 in paragraphs [0070] to [0077], which teachings are incorporated herein by reference as desirably applying to the capture fluid of the present invention.

The capture fluid can contain additives dissolved or dispersed therein. Desirable additives can include surface modifiers (functionalizing agents) that adhere to the surface of the nanoparticles as they are collected. Surface modifiers can act as compatibilizers that render the nanoparticles more compatible with the capture fluid or some other medium with which the nanoparticles need to be combined, can render the surface of the nanoparticles reactive for further chemical reactions, or can both impart compatibility and reactivity. Examples of additives that can be included in the capture fluid include hydrocarbons (such as 1-alkenes) to aid in dispersing nanoparticles in hydrophobic media, oligoglycols (such as allyl ethers) to aid in dispersing nanoparticles in hydrophilic media, terminal olefins containing functional groups such as alcohols, carboxylates, amines and protected versions of these for post-passivation conversion and extraction, and fluorocarbons bearing terminal olefins to aid in dispersing nanoparticles in fluoropolymers.

It is possible to recycle or reuse a capture fluid in VHFLPP processes. That is, nanoparticles can be collected in the same capture fluid for multiple runs of the VHFLPP process. Typically, nanoparticles are isolated from the capture fluid prior to reusing the capture fluid, but that is not necessary. For example, nanoparticles can be collected in a capture fluid, passivated and then isolated from the capture fluid (for example, by filtration or centrifugation). The remaining capture fluid can then be used in a subsequent VHFLPP process.

After collection silicon nanoparticles in a capture fluid it is desirable to passivate them, particularly if they are silicon nanoparticles, in order to provide stability to exposure to air. Silicon nanoparticles are readily passivated in a capture fluid by exposing the capture fluid containing silicon nanoparticles to a relatively humid atmosphere, typically at temperatures greater than 25° C. for a period of time. Moisture slowly permeates the capture fluid and reacts to form a passivating oxide layer on the silicon nanoparticles. For instance, one way to conduct passivation of silicon nanoparticles in a capture fluid is subject the nanoparticles and capture fluid to a temperature 23° C. or higher, typically a temperature of 50° C. or higher, 60° C. or higher, 65° C. or their, even 70° C. or higher, while at the same time typically 80° C. or lower, or 70° C. or lower, even 65° C. or lower, and an atmosphere at 85% relative humidity, preferably air, for a period of time that typically is 12 to 72 hours, and that can be even longer than 72 hours. In some instances the period of time can be 168 hours or more. Longer periods of time can result in a greater extent of oxidation of the silicon nanoparticle surface particularly in a fluid that has a low oxygen and moisture permeability.

Isolate the silicon nanoparticles from the capture fluid, typically by centrifugation followed by fluid removal and/or filtration. Then disperse the silicon nanoparticles into a sprayable fluid such as a solvent (for example, toluene). Then spray coat the dispersion of silicon nanoparticles in the sprayable fluid onto pieces of polymeric host matrix material and allow them to dry. The resulting pieces of polymeric hot material are coated with silicon nanoparticles.

### Direct Deposition Method

When collecting silicon nanoparticles directly onto a substrate (such as pieces of polymeric host matrix material), position the substrate in the collection chamber in the path of the flow of the gas stream containing the nanoparticles. As the nanoparticles contact the substrate they collect on the surface of the substrate. It is desirable to move the substrate as the gas stream containing the nanoparticles impinges it so as to help distribute nanoparticles over the surfaces of substrate rather than building up into clumps. For instance, the substrate can be in an open container that rotates or translates under the gas stream containing nanoparticles within the collection chamber. The resulting substrates (such as pieces of polymeric host matrix material) are coated with silicon nanoparticles.

It is desirable to passivate the silicon nanoparticles on the substrates prior to exposing them to air, particularly if the silicon nanoparticles are silicon quantum dots. One method of passivating the silicon nanoparticles is to submerge the host matrix particles that are coated with silicon nanoparticles in a protective fluid while in a vacuum or while under a dry inert atmosphere and then exposing the fluid to air in a controlled manner so as to control the rate as which oxygen and moisture reach the silicon nanoparticles so as to develop a protective oxide layer on the silicon nanoparticles without experiencing catastrophic exothermic degradation. Suitable protective fluids include capture fluids

One way to conduct passivation of silicon nanoparticle coated substrates in a protective fluid such as a capture fluid is to subject the nanoparticles and protective fluid to a temperature 23° C. or higher, typically a temperature of 50° C. or higher, 60° C. or higher, 65° C. or their, even 70° C. or higher, while at the same time typically 80° C. or lower, or 70° C. or lower, even 65° C. or lower, and an atmosphere at 85% relative humidity, preferably air, for a period of time that typically is 12 to 72 hours, and that can be even longer than 72 hours. In some instances the period of time can be 168 hours or more. Longer periods of time can result in a greater extent of oxidation of the silicon nanoparticle surface particularly in a protective fluid that has a low oxygen and moisture permeability.

### Deposition in Capture Fluid Method

The most desirable method for providing silicon nanoparticle coated pieces of polymeric host material is to directly coat the pieces in a capture fluid while collecting silicon nanoparticles in the capture fluid. The method captures silicon nanoparticles in a capture fluid as described for the Spray Coating Method, above. However, the capture fluid has pieces of polymeric host material at least partially submerged (preferably, entirely submerged) in the capture fluid while capturing the silicon nanoparticles. In this method, silicon nanoparticles enter the capture fluid and tend to disperse and then coat the pieces of polymeric host material in the capture fluid. This method typically results in a more uniform coating of the pieces of polymeric host material than is achievable by direct deposition method because the capture fluid acts as a dispersing agent for the silicon nanoparticle prior to the silicon nanoparticle contacting the pieces of polymeric host material. It is desirable to have the capture fluid in a container and to move the container while collecting nanoparticles in order to help disperse the nanoparticles throughout the capture fluid. For example, position a container containing particles of polymeric host matrix material in the collection chamber and rotate or translate the container as the gas stream containing the nanoparticles flows into the capture fluid.

The capture fluid can contain additives dissolved or dispersed therein. Desirable additives can include surface modifiers (functionalizing agents) that adhere to the surface of the nanoparticles as they are collected. Surface modifiers can act as compatibilizers that render the nanoparticles more compatible with the capture fluid or some other medium with which the nanoparticles need to be combined, can render the surface of the nanoparticles reactive for further chemical reactions, or can both impart compatibility and reactivity. Examples of additives that can be included in the capture fluid include hydrocarbons (such as 1-alkenes) to aid in dispersing nanoparticles in hydrophobic media, oligoglycols (such as allyl ethers) to aid in dispersing nanoparticles in hydrophilic media, terminal olefins containing functional groups such as alcohols, carboxylates, amines and protected versions of these for post-passivation conversion and extraction, and fluorocarbons bearing terminal olefins to aid in dispersing nanoparticles in fluoropolymers.

It is desirable to passivate the silicon nanoparticles coated on the pieces of polymeric host material prior to exposing them to air. It is most desirable to passivate the silicon nanoparticles while in the capture fluid. Silicon nanoparticles are readily passivated in a capture fluid by exposing the capture fluid containing silicon nanoparticles to a relatively humid atmosphere, typically at temperatures greater than 25° C. for a period of time. Moisture slowly permeates the capture fluid and reacts to form a passivating oxide layer on the silicon nanoparticles. For instance, one way to conduct passivation of silicon nanoparticles in a capture fluid is subject the nanoparticles and capture fluid to a temperature 23° C. or higher, typically a temperature of 50° C. or higher, 60° C. or higher, 65° C. or their, even 70° C. or higher, while at the same time typically 80° C. or lower, or 70° C. or lower, even 65° C. or lower, and an atmosphere at 85% relative humidity, preferably air, for a period of time that typically is 12 to 72 hours, and that can be even longer than 72 hours. In some instances the period of time can be 168 hours or more. Longer periods of time can result in a greater extent of oxidation of the silicon nanoparticle surface particularly in a fluid that has a low oxygen and moisture permeability.

The silicon nanoparticle coated pieces of polymeric host matrix material can be isolated from the capture fluid by, for example, filtration. Rinsing with a solvent can be desirable to remove residual capture fluid. The capture fluid can be reused if desired.

Softening pieces of polymeric host matrix material coated with silicon nanoparticles can occur by any means in the broadest scope of the invention. For instance, softening can occur by heating and/or adding solvent to a polymeric host matrix material coated with silicon nanoparticles to soften the polymeric host matrix material. The polymeric host matrix material should be softened sufficiently to allow blending of the pieces of host matrix material together to form a single mass of polymeric host matrix material. Blending can occur, for example, by hand using a stirrer or spatula, with a mechanical mixer, or by directing through an extruder. Upon mixing the softened pieces of polymeric host matrix material a single mass forms of polymeric host matrix material with silicon nanoparticle dispersed therein.

The single mass of host matrix material with silicon nanoparticles dispersed therein can be further processed. For example, the host matrix material can be further softened sufficiently to form a flowable composition and then the flowable composition can be allowed or caused to flow without mixing. Surprisingly, the silicon nanoparticles dispersed within the host matrix material tend to flow at a different rate than the host matrix material thereby resulting in a concentrating effect of silicon nanoparticles within the host matrix material. Typically, the silicon nanoparticles flow more slowly than the host matrix material resulting in a higher concentration in the host matrix material where host matrix material has flowed without carrying the silicon nanoparticle with it in a proportional concentration. Alternatively, or additionally, the single mass of polymeric host matrix material with silicon nanoparticles dispersed therein can be formed into a film of host matrix material having silicon nanoparticles dispersed therein by compressing the softened single mass of polymeric host matrix material with silicon nanoparticles dispersed therein. Such a compression to form a film can occur in a batch process in a press or in a continuous manner such as through rollers. Such films can be particularly useful as agricultural films, especially when the silicon nanoparticles are silicon quantum dots that absorb less agriculturally friendly wavelengths of light (for example, light having a wavelength of less than 400 nanometers) and luminesce at more agriculturally friendly wavelengths of light. Agriculturally friendly wavelengths of light are typically in a range of 600-750 nanometers. Then the resulting agricultural films serve to convert less useful or even harmful wavelengths of light into useful wavelengths of light. For example, less useful or harmful wavelength of light can be ultraviolet light that damages plants and more useful wavelengths of light can be blue, green or red wavelengths that plants can use in photosynthesis. Agricultural films are useful as covers for plants or even as covers for greenhouses.

The single mass of host matrix material with silicon nanoparticle dispersed therein can also, or alternatively, be extruded to form polymer compositions of various types, including pellets of host matrix material with silicon nanoparticles dispersed therein.

### EXAMPLES

### Materials

Table 1 lists the components for use in preparing the samples that follow.

TABLE 1

| Component | Description | Source |
|---|---|---|
| Nanoparticle | SiH₄/Ar | Air Liquide as SiH4-EG2 |
| Precursor | (2% SiH₄ by mass in Ar) | (99.999%)/Ar-EG3 |
| | | (99.9999%) 2% by mass. |
| Ar Carrier Gas | Argon (99.9999%) | Air Liquide as Argon-EG3 |
| | | (99.9999%). |
| H₂ Carrier Gas | Hydrogen (99.999%) | Air Liquide as Hydrogen- |
| | | EG1 (99.999%). |
| Chlorine Dopant | Chlorine (99.99%) | Air Liquide as Chlorine-EG1 |
| | | (99.99%). |
| LDPE | Low density polyethylene with an advertised | Catalog number 428043 |
| | melt index of 25 g/10 min | from Millipore Sigma. |
| 1-octadecene | 1-octadecene (CAS number 112-88-9) | Catalog number 74740 from |
| | | Millipore Sigma. |
| Mineral oil | Mineral oil (CAS number 8042-47-5) | Catalog number O121 from |
| | | Fisher Scientific. |
| Toluene | Toluene (CAS number 108-88-3) | Catalog number |
| | | AA31755M1 from Fisher |
| | | Scientific. |
| PVB sheets | Poly(vinyl butyral) sheets (CAS number 63148- | Available under the name |
| | 65-2) with dimensions: 31 cm × 1.5 cm × 31 cm | SentryGlas ™ from Kuraray. |
| | and stored in desiccator over anhydrous | |
| | calcium sulfate prior to use. | |
| PLA | Poly (lactic acid) pieces are cut from | PLA cups are available Perk |
| | poly(lactic acid) cups. | cold cups from Staples (item |
| | | number 24394121). |
| PTFE Sheets | Polytetrafluoroethylene sheets (0.3175 cm × | Available as product |
| | 15.24 cm × 15.24 cm) | number 55RA05 from USA |
| | | Sealing. |

SentryGlas is a trademark of Kuraray Amberica.

### Samples Using Deposition Onto Particles of Polymeric Host Matrix Material in Capture Fluid

### Preparation of SiQD-Coated LDPE Particles

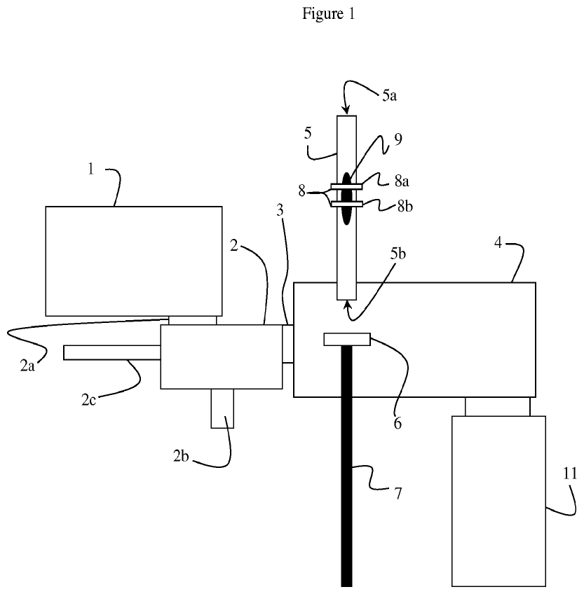

The following procedure refers to FIG. 1 for a general image of the components of the VHFLP process used to prepare silicon quantum dots (SiQDs).

In a glove box 1, place 8 grams (g) of mineral oil and 7.1 g of LDPE pellets into an open container (“capture fluid reservoir”) 6 and then transfer the capture fluid reservoir into load lock 2 through gate valve 2a. Evacuate load lock 2 to a pressure below 2.67 Pa using a roughing pump. Evacuate main collection chamber 4 to a pressure below 6.67×10⁻⁵ Pa using high vacuum pump 11 (a turbo-molecular pump with a pump rate of 600 liters per second that is backed by a roughing pump (Ebara S50 semiconductor pump with pump rate of 5,000 liters per minute)). Transfer the capture fluid reservoir 6 through gate valve 3 into main collection chamber 4 using transfer arm 2c and position it on the capture fluid reservoir holder 7. Position the capture fluid reservoir 6 to 6.5 centimeters below orifice 5b using capture fluid reservoir holder 7. Close gate valve 3 and evacuate the main capture chamber 4 to a pressure of 6.67×10⁻⁵ Pa. Rotate the capture fluid reservoir holder 7 and, therefore the capture fluid reservoir 6, at a rate of 12 revolutions per minute.

Feed a gas stream of 35 standard cubic centimeters per minute (SCCM) of Nanoparticle Precursor and 55 SCCM of Ar Carrier Gas into entrance end 5a and through dielectric discharge tube 5 and out discharge tube orifice 5b into the main collection chamber 4. Strike a plasma 9 in discharge tube 5 by applying an alternating sine wave bias to electrodes 8a and 8b of dual copper electrode 8. Generate the sine wave bias with a Tektronix AFG 3252 function generator and an Electronic and Innovation 3200L Class A radio frequency amplifier connected to the electrodes. The sine wave bias across the electrodes produces a capacitively coupled very high frequency (frequency from 90-500 Megahertz) plasma within the dielectric discharge tube. Tune the frequency source to provide the maximum power coupled into the plasma while minimizing the drive amplitude of the sine wave. The coupled power density of the plasma is greater than 130 Watts per square centimeter (W/cm²). Silicon nanoparticles form in the plasma 9 and exit the dielectric discharge tube through discharge tube orifice 5b in the main collection chamber 4 into the capture fluid in the capture fluid reservoir and coat the LDPE pellets in the capture fluid.

Continue generating and collecting silicon nanoparticles in such a manner for 70 minutes and then turn off the power to electrodes 8a and 8b. Open gate valve 3 and transfer the capture fluid reservoir back into the load lock 2 using transfer arm 2c. Transfer the capture fluid reservoir to a glove box and pour the contents of the capture fluid reservoir into a glass jar. Transfer the glass jar to a humidity chamber (Associated Environmental Systems, model LH-10) that is maintained at 60° C. and 85% relative humidity. Leave the glass jar uncapped in the humidity chamber for 7 days to allow the silicon nanoparticles to slowly passivate by forming an oxide coating.

Isolate the silicon nanoparticle coated LDPE pellets from the capture fluid by transferring the contents of the capture fluid reservoir 6 into a syringe (COVIDIENT Luer Lock Sterile Syringe, 60 cubic centimeter, Grainger catalog number 9VZF7) fitted with a filter (polytetrafluoroethylene syringe filter, 0.22 micrometers CELLTREAT brand filter). Depress the plunger on the syringe to drive the capture fluid through the filter and out of the syringe while retaining the silicon nanoparticle coated LPDE pellets in the syringe. Add toluene to the syringe with the silicon nanoparticle coated LPDE pellets to rinse the pellets and then express the toluene through the filter and out of the syringe. Rinse again with toluene in like manner. Dry the resulting silicon nanoparticle coated LPDE pellets in an oven at 60° C. The dried silicon nanoparticle coated LPDE pellets demonstrate visible photoluminescence upon exposure to ultraviolet light (365 nanometer wavelength from real UV LED flashlight with BLACKOUT™ Filter Technology from Waveform Lighting, catalog number 7023) indicating that the silicon nanoparticles are silicon quantum dots.

Sample 1: LDPE Film with Silicon Quantum Dots Dispersed Therein

Place 3-4 grams of silicon nanoparticle coated LDPE pellets between two PTFE Sheets and place the resulting PTFE sheets and silicon nanoparticle coated LDPE pellets in a vacuum bag (FoodSaver vacuum Seal Rolls item number 191396). Evacuate the vacuum bag (using FoodSaver part number FSSMSL0160-000) and then, while in the vacuum bag, compress the two PTFE Sheets against the silicon nanoparticle coated LDPE pellets at 150° C. for 30 minutes using a clamshell heat press (Geo Knight & Co., model DK16) and a pressure on the clamshell heat press's pressure scale in a range of 4-6 to produce a LDPE film between the PTFE Sheets. Remove the LDPE film and PTFE Sheets from the vacuum bag. The LDPE film luminesces when exposed ultraviolet light (365 nanometer wavelength from real UV LED flashlight with BLACKOUT™ Filter Technology from Waveform Lighting, catalog number 7023) indicating it contains silicon quantum dots dispersed therein.

Sample 2: LDPE Monolith from Silicon Nanoparticle Coated LPDE Pellets Mixed with Non-Coated LDPE Pellets

Blend silicon nanoparticle coated LDPE pellets with LDPE pellets that are not coated with silicon nanoparticles by hand while heating to a temperature sufficient to cause the LDPE pellets to soften and flow into order to form a single molten polymer mixture. Allow the single molten polymer mixture to cool into a LDPE monolith. The LDPE monolith luminesces when exposed ultraviolet light (365 nanometer wavelength from real UV LED flashlight with BLACKOUT™ Filter Technology from Waveform Lighting, catalog number 7023) indicating it contains silicon quantum dots dispersed therein.

### Samples Using Direct Deposition Onto Particles of Polymeric Host Matrix Material

In a glove box, place one gram of LDPE pellets into an open container (“capture fluid reservoir”) 6 without any capture fluid and then transfer the capture fluid reservoir into load lock 2. Evacuate load lock 2 to a pressure below 2.67 Pa using a roughing pump. Evacuate main collection chamber 4 to a pressure below 6.67×10⁻⁵ Pa using high vacuum pump 11 (a turbo-molecular pump with a pump rate of 600 liters per second that is backed by a roughing pump (Ebara S50 semiconductor pump with pump rate of 5,000 liters per minute)). Transfer the capture fluid reservoir through gate valve 3 into main collection chamber 4 using transfer arm 2c and position it on the capture fluid reservoir holder 7. Position the capture fluid reservoir 6.5 centimeters below orifice 5b using capture fluid reservoir holder 7. Close gate valve 3 and evacuate the main capture chamber 4 to a pressure of 6.67×10⁻⁵ Pa. Rotate the capture fluid reservoir holder 7 and, therefore the capture fluid reservoir, at a rate of 12 revolutions per minute.

Feed a gas stream of 35 SCCM of Nanoparticle Precursor, 50 SCCM of Ar Carrier Gas, 3 SCCM of H₂ Carrier Gas and 0.3 SCCM of Chlorine Dopant into entrance end 5a and through dielectric discharge tube 5 and out discharge tube orifice 5b into the main collection chamber 4. Strike a plasma 9 in discharge tube 5 by applying an alternating sine wave bias to electrodes 8a and 8b of dual copper electrode 8. Generate the sine wave bias with a Tektronix AFG 3252 function generator and an Electronic and Innovation 3200L Class A radio frequency amplifier connected to the electrodes. The sine wave bias across the electrodes produces a capacitively coupled very high frequency (frequency from 90-500 Megahertz) plasma within the dielectric discharge tube. Tune the frequency source to provide the maximum power coupled into the plasma while minimizing the drive amplitude of the sine wave. The coupled power density of the plasma is greater than 130 Watts per square centimeter (W/cm²). Silicon nanoparticles form in the plasma 9 and exit the dielectric discharge tube through discharge tube orifice 5b in the main collection chamber 4 onto the LDPE pellets in the capture fluid reservoir to coat the LDPE pellets with silicon nanoparticles.

Continue generating and collecting silicon nanoparticles in such a manner for 45 minutes and then turn off the power to electrodes 8a and 8b. Open gate valve 3 and transfer the capture fluid reservoir back into the load lock 2 using transfer arm 2c. Transfer the capture fluid reservoir to a glove box and add 12 g of Mineral Oil to the capture fluid reservoir. Pour the contents of the capture fluid reservoir into a glass jar. Transfer the glass jar to a humidity chamber (Associated Environmental Systems, model LH-10) that is maintained at 60° C. and 85% relative humidity. Leave the glass jar uncapped in the humidity chamber for 7 days to allow the silicon nanoparticles to slowly passivate by forming an oxide coating.

Isolate the silicon nanoparticle coated LDPE pellets from the Mineral Oil by transferring the contents of the capture fluid reservoir into a syringe (COVIDIENT Luer Lock Sterile Syringe, 60 cubic centimeter, Grainger catalog number 9VZF7) fitted with a filter (polytetrafluoroethylene syringe filter, 0.22 micrometers CELLTREAT brand filter). Depress the plunger on the syringe to drive the Mineral Oil through the filter and out of the syringe while retaining the silicon nanoparticle coated LPDE pellets in the syringe. Add toluene to the syringe with the silicon nanoparticle coated LPDE pellets to rinse the pellets and then express the toluene through the filter and out of the syringe. Rinse again with toluene in like manner. Dry the resulting silicon nanoparticle coated LPDE pellets in an oven at 60° C. The dried silicon nanoparticle coated LPDE pellets demonstrate visible photoluminescence upon exposure to ultraviolet light (365 nanometer wavelength from real UV LED flashlight with BLACKOUT™ Filter Technology from Waveform Lighting, catalog number 7023) indicating that the silicon nanoparticles are silicon quantum dots.

Sample 3: LDPE Film with Silicon Quantum Dots Dispersed Therein

Repeat the process for Sample 1 using the silicon nanoparticle coated LPDE pellets prepared by the Direct Deposition Onto Particles of Polymeric Host Matrix Material procedure. The LDPE film luminesces when exposed ultraviolet light (365 nanometer wavelength from real UV LED flashlight with BLACKOUT™ Filter Technology from Waveform Lighting, catalog number 7023) indicating it contains silicon quantum dots dispersed therein.

Samples Using Spray Coating Silicon Nanoparticles onto Particles of Polymeric Host Matrix Material

For these sample, prepare a dispersion of silicon nanoparticles in a fluid and then spray coat the silicon nanoparticle onto particles of polymeric host matrix material to form silicon nanoparticle coated particles. Then form a polymer material using the silicon nanoparticle coated particles.

### Preparation of Silicon Nanoparticle Dispersion

In a glove box, place 12 g of mineral oil capture fluid into an open container (“capture fluid reservoir”) 6. The capture fluid is a 5 weight-percent solution of 1-octadecene in Mineral Oil. Transfer the capture fluid reservoir into load lock 2. Evacuate load lock 2 to a pressure below 2.67 Pa using a roughing pump. Evacuate main collection chamber 4 to a pressure below 6.67×10⁻⁵ Pa using high vacuum pump 11 (a turbo-molecular pump with a pump rate of 600 liters per second that is backed by a roughing pump (Ebara S50 semiconductor pump with pump rate of 5,000 liters per minute)). Transfer the capture fluid reservoir through gate valve 3 into main collection chamber 4 using transfer arm 2c and position it on the capture fluid reservoir holder 7. Position the capture fluid reservoir 6.5 centimeters below orifice 5b using capture fluid reservoir holder 7. Close gate valve 3 and evacuate the main capture chamber 4 to a pressure of 6.67×10⁻⁵ Pa. Rotate the capture fluid reservoir holder 7 and, therefore the capture fluid reservoir, at a rate of 12 revolutions per minute.

Feed a gas stream of 50 SCCM of Nanoparticle Precursor and 7 SCCM of H₂ Carrier Gas into entrance end 5a and through dielectric discharge tube 5 and out discharge tube orifice 5b into the main collection chamber 4. Strike a plasma 9 in discharge tube 5 by applying an alternating sine wave bias to electrodes 8a and 8b of dual copper electrode 8. Generate the sine wave bias with a Tektronix AFG 3252 function generator and an Electronic and Innovation 3200L Class A radio frequency amplifier connected to the electrodes. The sine wave bias across the electrodes produces a capacitively coupled very high frequency (frequency from 90-500 Megahertz) plasma within the dielectric discharge tube. Tune the frequency source to provide the maximum power coupled into the plasma while minimizing the drive amplitude of the sine wave. The coupled power density of the plasma is greater than 130 Watts per square centimeter (W/cm²). Silicon nanoparticles form in the plasma 9 and exit the dielectric discharge tube through discharge tube orifice 5b in the main collection chamber 4 into the capture fluid in the capture fluid reservoir.

Continue generating and collecting silicon nanoparticles in such a manner for 95 minutes and then turn off the power to electrodes 8a and 8b. Open gate valve 3 and transfer the capture fluid reservoir back into the load lock 2 using transfer arm 2c. Transfer the capture fluid reservoir to a glove box and pour the contents of the capture fluid reservoir into a glass jar and place the glass jar into a sonic bath (Branson 2510, 40 kiloHertz) and apply sonication agitation for one hour. Then, transfer the glass jar to a humidity chamber (Associated Environmental Systems, model LH-10) that is maintained at 60° C. and 85% relative humidity. Leave the glass jar uncapped in the humidity chamber for 7 days to allow the silicon nanoparticles to slowly passivate by forming an oxide coating.

Transfer the solutions of capture fluid and silicon nanoparticles into centrifuge tubes and centrifuge using a Sorvall Biofuge Primo centrifuge). Use a pipette to remove the supernatant capture fluid from the centrifuge tubes leaving behind the silicon nanoparticles. Fill the centrifuge tubes with toluene and gently agitate by hand to rinse the silicon nanoparticles and then centrifuge the centrifuge tubes to separate the toluene from the silicon nanoparticles. Pipette off the toluene. Repeat the toluene rinse and separation by centrifuge three times. Then, add toluene to the centrifuge tubes containing the silicon nanoparticles and sonicate them as described above to produce clear dispersions of silicon nanoparticles in toluene. The dispersions demonstrate visible photoluminescence upon exposure to ultraviolet light (365 nanometer wavelength from real UV LED flashlight with BLACKOUT™ Filter Technology from Waveform Lighting, catalog number 7023) indicating that the silicon nanoparticles are silicon quantum dots.

Sample 4: Spray Coating Silicon Quantum Dots on LDPE and Forming Therefrom a LDPE film with Silicon Quantum Dots Dispersed Therein

Using an airbrush (Central Pneumatic, item 95810), spray the dispersion of silicon nanoparticles in toluene onto LDPE pellets to form silicon nanoparticle coated LDPE pellets. Spray 10 milliliters of a 1,000 weight parts silicon nanoparticles per million weight parts of toluene onto the LDPE pellets. Dry the silicon nanoparticle coated LDPE pellets for 24 hours at 60° C. in an oven. The dried silicon nanoparticle coated LPDE pellets demonstrate visible photoluminescence upon exposure to ultraviolet light (365 nanometer wavelength from real UV LED flashlight with BLACKOUT™ Filter Technology from Waveform Lighting, catalog number 7023) indicating that the silicon nanoparticles are silicon quantum dots.

Place 3-4 grams of silicon nanoparticle coated LDPE pellets between two PTFE Sheets and place the resulting PTFE sheets and silicon nanoparticle coated LDPE pellets in a vacuum bag (FoodSaver vacuum Seal Rolls item number 191396). Evacuate the vacuum bag (using FoodSaver part number FSSMSL0160-000) and then, while in the vacuum bag, compress the two PTFE Sheets against the silicon nanoparticle coated LDPE pellets at 150° C. for 30 minutes using a clamshell heat press (Geo Knight & Co., model DK16) and a pressure on the clamshell heat press's pressure scale in a range of 4-6 to produce a LDPE film between the PTFE Sheets. Remove the LDPE film and PTFE Sheets from the vacuum bag. The LDPE film luminesces when exposed ultraviolet light (365 nanometer wavelength from real UV LED flashlight with BLACKOUT™ Filter Technology from Waveform Lighting, catalog number 7023) indicating it contains silicon quantum dots dispersed therein.

Sample 5: Spray Coating Silicon Quantum Dots on PVB Sheets and Forming Therefrom a PVB film with Silicon Quantum Dots Dispersed Therein

Cut a PVB sheet into two PVB sheets having dimensions of 7.62 cm by 2.54 cm. Using an airbrush (Central Pneumatic, item 95810), spray the dispersion of silicon nanoparticles in toluene onto one side of each of the two PVB sheets to form silicon nanoparticle coated PVB sheets. Spray 10 milliliters of a 1,000 weight parts silicon nanoparticles per million weight parts of toluene onto the PVB sheets. Allow the silicon nanoparticle coated PVB sheets to dry at 25° C. Place the silicon nanoparticle coated PVB sheet on top of one another with the silicon nanoparticle coated surfaces contacting one another and place between two PTFE Sheets in a vacuum bag (FoodSaver vacuum Seal Rolls item number 191396). Evacuate the vacuum bag (using FoodSaver part number FSSMSL0160-000) and then, while in the vacuum bag, compress the two PTFE Sheets against the silicon nanoparticle coated PVB sheets at 150° C. for 30 minutes using a clamshell heat press (Geo Knight & Co., model DK16) and a pressure on the clamshell heat press's pressure scale in a range of 4-6 to produce a single PVB film between the PTFE Sheets. Remove the PVB film and PTFE Sheets from the vacuum bag. The PVB film luminesces when exposed ultraviolet light (365 nanometer wavelength from real UV LED flashlight with BLACKOUT™ Filter Technology from Waveform Lighting, catalog number 7023) indicating it contains silicon quantum dots dispersed therein.

Place the resulting PVB film containing silicon nanoparticles between two glass microscope slides and place into a vacuum bag (FoodSaver vacuum Seal Rolls item number 191396). Evacuate the vacuum bag (using FoodSaver part number FSSMSL0160-000) and then, while in the vacuum bag, compress the two PTFE Sheets against the silicon nanoparticle coated PVB sheets at 120° C. for 10 minutes using a clamshell heat press (Geo Knight & Co., model DK16) and a pressure on the clamshell heat press's pressure scale in a range of 4-6 to produce a laminated glass sample of two pieces of glass laminated together the silicon nanoparticle containing PVB between them. The laminated glass sample luminesces when exposed ultraviolet light (365 nanometer wavelength from real UV LED flashlight with BLACKOUT™ Filter Technology from Waveform Lighting, catalog number 7023) indicating it contains silicon quantum dots.

Sample 6: Spray Coating Silicon Quantum Dots onto PLA and Forming Therefrom a PLA film with Silicon Quantum Dots Dispersed Therein

Cut two pieces of PLA (“PLA sheets”) from the PLA cold cups to provide pieces having dimensions of 7.62 cm by 2.54 cm. Using an airbrush (Central Pneumatic, item 95810), spray the dispersion of silicon nanoparticles in toluene onto one side of each of the two PLA sheets to form silicon nanoparticle coated PLA sheets. Spray 10 milliliters of a 1,000 weight parts silicon nanoparticles per million weight parts of toluene onto the PLA sheets. Allow the silicon nanoparticle coated PLA sheets to dry at 25° C. Place the silicon nanoparticle coated PLA sheets on top of one another with the silicon nanoparticle coated surfaces contacting one another and place between two PTFE Sheets in a vacuum bag (FoodSaver vacuum Seal Rolls item number 191396). Evacuate the vacuum bag (using FoodSaver part number FSSMSL0160-000) and then, while in the vacuum bag, compress the two PTFE Sheets against the silicon nanoparticle coated PLA sheets at 180° C. for 30 minutes using a clamshell heat press (Geo Knight & Co., model DK16) and a pressure on the clamshell heat press's pressure scale in a range of 4-6 to produce a single PLA film between the PTFE Sheets. Remove the PLA film and PTFE Sheets from the vacuum bag. The PLA film luminesces when exposed ultraviolet light (365 nanometer wavelength from real UV LED flashlight with BLACKOUT™ Filter Technology from Waveform Lighting, catalog number 7023) indicating it contains silicon quantum dots dispersed therein.

Cut a one centimeter by one centimeter piece from the PLA film and dissolve in aqueous 50% potassium hydroxide solution. The PLA quickly decomposed to potassium lactant The silicon quantum dots are etched to potassium silicate as evidenced by a rapid loss of orange photoluminescence. This demonstrates a sample of polymer film with silicon quantum dots dispersed therein that can be rapidly degraded at the end of its service time.

1. A method for preparing a polymeric host matrix material with silicon nanoparticles dispersed therein, the method comprising:
a. providing pieces of polymeric host matrix material coated with silicon nanoparticles;
b. softening the pieces of polymeric host matrix material coated with silicon nanoparticles to form softened pieces of polymeric host matrix material; and
c. blending the softened pieces of polymeric host matrix material together with the silicon nanoparticles on the surface of the softened pieces of polymeric host matrix material to form a single mass of polymeric host matrix material with silicon nanoparticles dispersed therein; wherein the silicon nanoparticles are silicon quantum dots and wherein the polymeric host material is a thermoplastic polymer composition.

2. (canceled)

3. The method of claim 1, wherein the silicon nanoparticle are passivated silicon quantum dots.

4. The method of claim 3, further comprising forming an oxide coating on silicon quantum dots after then are made so as to form a passivating oxide coating on silicon quantum dots.

5. The method of claim 1, further comprising providing the pieces of polymeric host matrix material coated with silicon nanoparticles by any one or any combination of the following methods:
a. directly depositing silicon nanoparticles onto the pieces of polymeric host matrix material as the silicon nanoparticles are made;
b. depositing silicon nanoparticle into a capture fluid that contains pieces of polymeric host matrix material as the silicon nanoparticles are made; and
c. spray-coating pieces of polymeric host matrix material with a solvent dispersion of silicon nanoparticles.

6. The method of claim 5, further comprising forming the silicon nanoparticles using a very high frequency low pressure plasma process.

7. The method of claim 6, wherein the very high frequency low pressure plasma process includes capturing the silicon nanoparticles in a capture fluid that comprise a functionalizing agent.

8. (canceled)

9. The method of claim 1, wherein the single mass of polymeric host material with silicon nanoparticles dispersed therein is further formed into a polymeric film and the silicon nanoparticles are quantum dots that absorb less agriculturally friendly wavelengths of light having a wavelength of less than 400 nanometers and luminesce at more agriculturally friendly wavelengths of light having a wavelength in a range of 600-750 nanometers.

10. The method of claim 1, further comprising a step of softening the single mass of polymeric host matrix material with silicon nanoparticles dispersed therein if it is not already in a flowable state to form a flowable polymer composition and then allowing or causing the flowable polymer composition to flow without mixing to achieve a differential concentration of silicon nanoparticles in the polymeric host matrix material.
